(19) United States
(12) Patent Application Publication
(10) Pub. No.: US 2007/0137948 A1
(43) Pub. Date: Jun. 21, 2007

(54) Bicycle brake mechanism

(76) Inventors: Montanari Sandro, Ta-Li City (TW); Righi Ermanno, Ta-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/305,236

(22) Filed: Dec. 19, 2005

(51) Int. Cl. B62L 3/00

(52) U.S. Cl. 188/24.22

(57) ABSTRACT

A bicycle brake mechanism includes a body located above a front wheel and a pivotable member is pivotably connected to the body. A brake cable extends through the front fork and is connected to the pivotable member. Two brake arms are located on two sides of the rim and two respective first ends of two link units are respectively connected to two ends of each of the brake arms. The two respective second ends of the links units are connected to two ends of the body. One end of each of the two brake arms is pushed by the pivotable member when the brake cable is pulled. The two link units make the two brake arms to be simultaneously moved to stop the rim.

### FIELD OF THE INVENTION

The present invention relates to a bicycle brake mechanism which includes links to activate the two brake pads to step the rim simultaneously.

### BACKGROUND OF THE INVENTION

Conventional brake systems includes disk brake system and caliper brake system. The disk brake system includes complicated mechanism and can brake the wheel sharply, the caliper brake system is economically manufactured and is suitable for stop wheels at slow speed. The disk brake system uses hydraulic oil to activate the brake action and the caliper brake system uses brake cables to pivot two brake pads to stop the wheel. The brake cable is connected to a yoke cable which has two ends respectively connected to two brake arms so that when the brake cable pulls the yoke cable, the two brake arms are pivoted and the brake pads on the two brake arms are move to stop the wheel. It is noted that the two brake pads cannot contact the rim simultaneously, in other words, one of the pads contacts the rim first so that the rim is applied by a force in one direction, and then the other brake pad contact the rim in opposite direction. Because at the beginning of the braking action, only one brake pad is in contact with the rim so that the speed of rim does not reduces as desired and the brake distance is therefore prolonged.

The present invention intends to provide a bicycle brake mechanism whose brake pads are in contact with the wheel rim simultaneously to effectively stop the wheel.

The present invention intends to provide a bicycle mechanism wherein the brake cable extends through the front fork.

### SUMMARY OF THE INVENTION

The present invention relates to a bicycle brake mechanism which comprises a body located above a front wheel and a pivotable member is pivotably connected to the body and connected to a brake cable. Two brake arms are located at inside of the body and movably connected to the body by two tubes extending through two elongate holes in the body. Each brake arms has a brake pad connected thereto. The two tubes are in contact with the pivotable member so that the two brake arms are moved when the pivotable member is pivoted by pulling the brake cable. Two link units are pivotably connected to two ends of each of the brake arms and the body so that the two brake arms are moved simultaneously by the two link units.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the brake mechanism of the present invention;

FIG. 2 is a perspective view to show the brake mechanism of the present invention;

FIG. 3 is a side view to show the brake mechanism of the present invention;

FIG. 4 is a perspective view, viewed from an underside of the brake mechanism of the present invention;

FIG. 5 shows a bottom view of the brake mechanism of the present invention;

FIG. 6 shows a front view of the brake mechanism of the present invention;

FIG. 7 shows that the brake cable is not yet pulled;

FIG. 8 shows that the brake cable is pulled an the brake arms are moved, and

FIG. 9 is a bottom view to show the link units when the brake cable is pulled.

### DETAILED DESCRIPTION OF THE PREFERRED EMBODIMENT

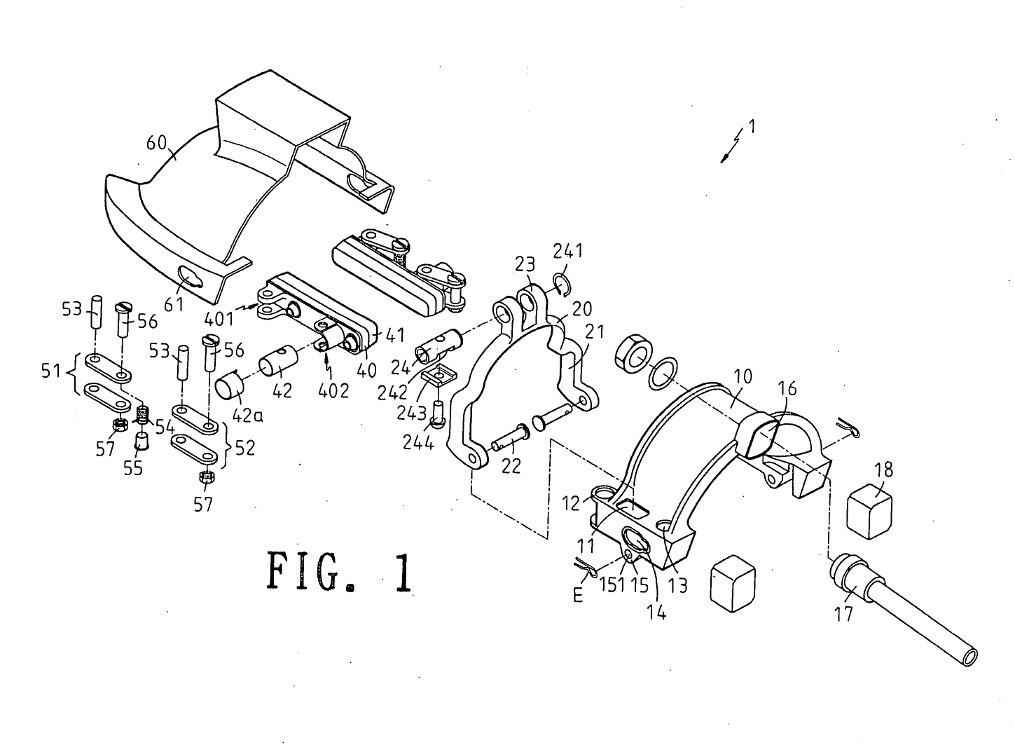

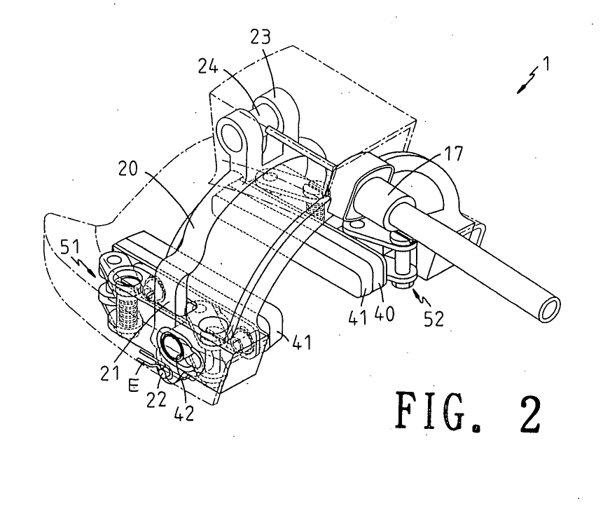

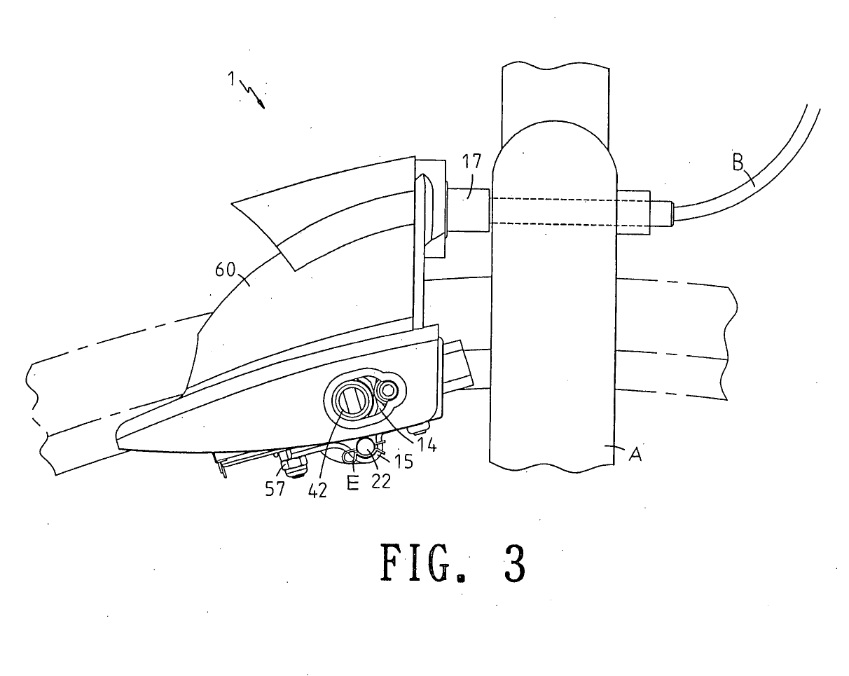

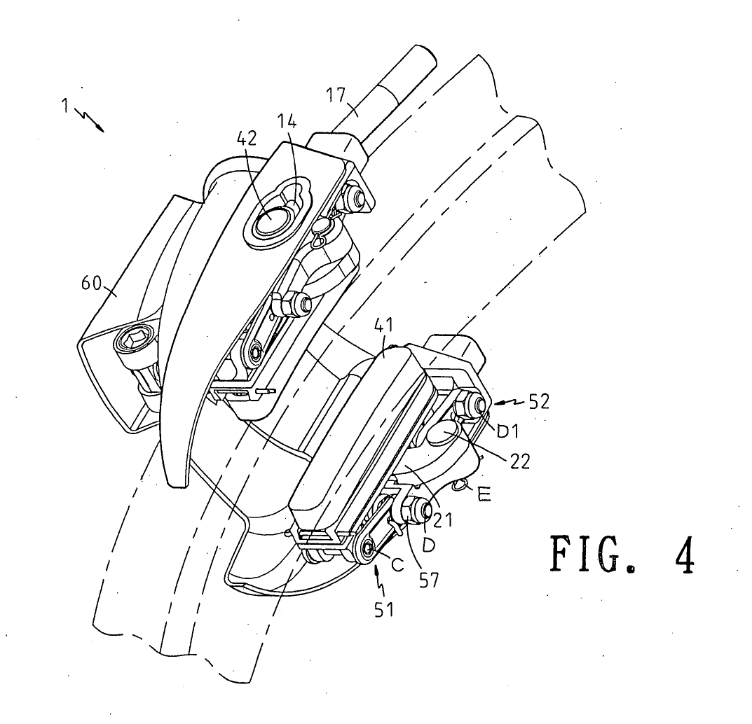

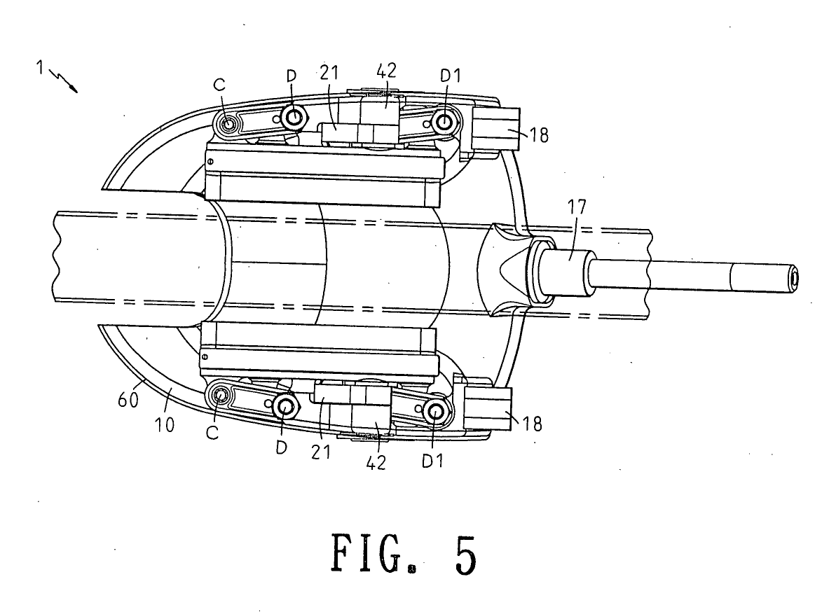

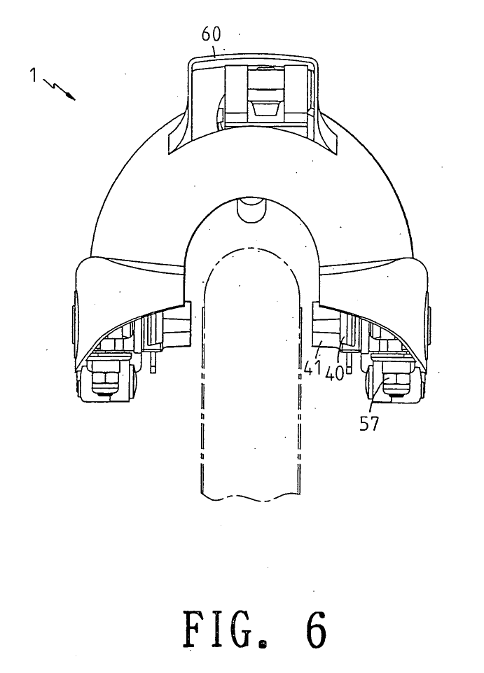

Referring to FIGS. 1 to 7, the bicycle brake mechanism 1 of the present invention comprises a U-shaped body 10 which is located above a front wheel and a through hole 16 is defined in a top of the body 10. A connector 17 is engaged with the through hole 16 so that the brake cable “B” extends through the front fork “A”, the connector 17, and the through hole 16 and is then connected with a pivotable member 20 which will be described hereinafter. Two slots 11 are defined through a top of two ends of the body 10 and two first elongate holes 14 are defined through a side of each of the two ends of the body 10. Two plates 15 extend from two respective lower edges of the two ends of the body 10 and two connection lugs 12 extend from each of the two ends of the body 10 and located opposite to the front fork “A”. Two cushion members 18 are connected to the two ends of the body 10 so as to prevent impact with the front fork “A”.

The pivotable member 20 includes two legs 21 which movably extend through the two slots 11 and each leg 21 includes an L-shaped end. Two pins 22 extend through the two L-shaped ends and two holes 151 in the two plates 15 to pivotably connect the pivotable member 20 to the body 10. The two pins 22 each have an aperture and a spring clip “E” extends through the aperture to prevent the pin 22 from being pulled backward through the two holes 151 in the two plates 15 of the body 10. The pivotable member 20 has two top lugs 23 on a center thereof and a securing unit is connected to the two top lugs 23. The securing unit includes a tubular member 24 which extends through the two top lugs 23 and includes a recess 242 defined in an outer periphery thereof. The tubular member 24 has a groove defined in an outer periphery of an end thereof and a C-clip 241 is engaged with the groove to position the tubular member 24. A securing plate 243 is engaged with the recess 242 and a bolt 244 extends through the securing plate 243 so as secure the brake cable “B” between the securing plate 243 and the recess 242.

Two brake arms 40 are located at inside of the body 10 and movably connected to the body 10 by two tubes 42. Each of the brake arms 40 has a brake pad 41 connected thereto and the two brake pads 41 are located on two sides of the wheel rim. The two tubes 42 are located on two respective horizontal sections of the L-shaped ends of the pivotable member 20 so that the two brake arms 40 are moved when the pivotable member 20 is pivoted. Each of the brake arms 40 has two first lugs 401 extending from a first end thereof and two second lugs 402 extending from a second end thereof. The two tubes 42 are respectively connected to the second lugs 402 of the two brake arms 40 and extend through two first elongate holes 14 defined through the two ends of the body 10. Each of the tubes 42 has an end cap 42a connected to a distal end thereof to ensure that the tubes 42 will not drop from the first elongate holes 14 of the body 10.

Two link units are pivotably connected to two ends of each of the brake arms 40 and the body 10 so that the two brake arms 40 are moved simultaneously. Each of the link units includes two first links 51 and two second links 52, each of the first and second links 52 are ova plates. The first links 51 have a first end pivotably connected to the first lugs 401 of each of the two brake arms 40, a second end of the first links 51 are pivotably connected to connection lugs 12 on the body 10. The first links 52 have a first end pivotably connected to the second lugs 402 of each of the two brake arms 40, a second end of the second links 52 are pivotably connected to a through hole 13 in each of the two ends of the body 10.

A rod 53 extends through the first end of each of the first links 51 and the first lugs 401 of each of the brake arms 40 to form a first pivotable portion “C”. A bolt 56 extends through the second end of each of the first links 51, a torsion spring 54, a support tube 55 for receiving the torsion spring 54 and the connection lugs 12 of each end of the body 10 and is connected to a nut 57 so as to form a first positioning portion “D”. Another rod 53 extends through the first end of each of the second links 52, the tube 42 between the second lugs 402 and the second lugs 402 of each of the brake arms 40 to form a second pivotable portion “C1”. Another bolt 56 extends through the second end of each of the second links 52 and the through hole 13 of the body 10 and is connected with another a nut 57 so as to form a second positioning portion “D1”.

A top cap 60 is mounted on the body 10 and includes two second elongate holes 61 which are in alignment with the first elongate holes 14 of the body 10, the tubes 42 extend through the two second elongate holes 61.

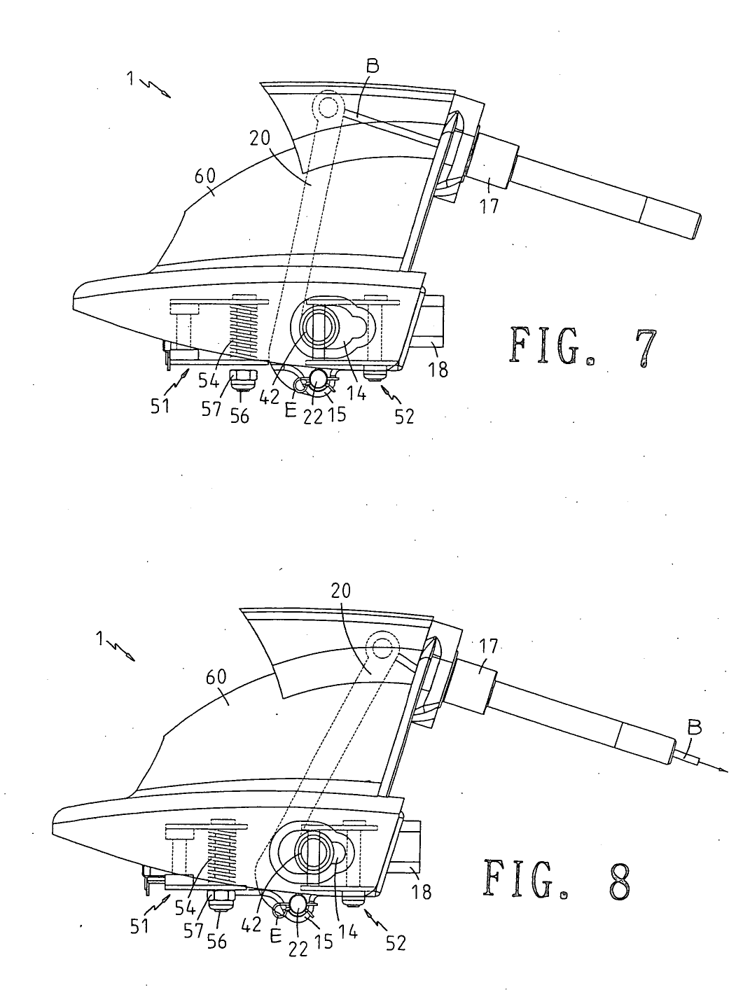

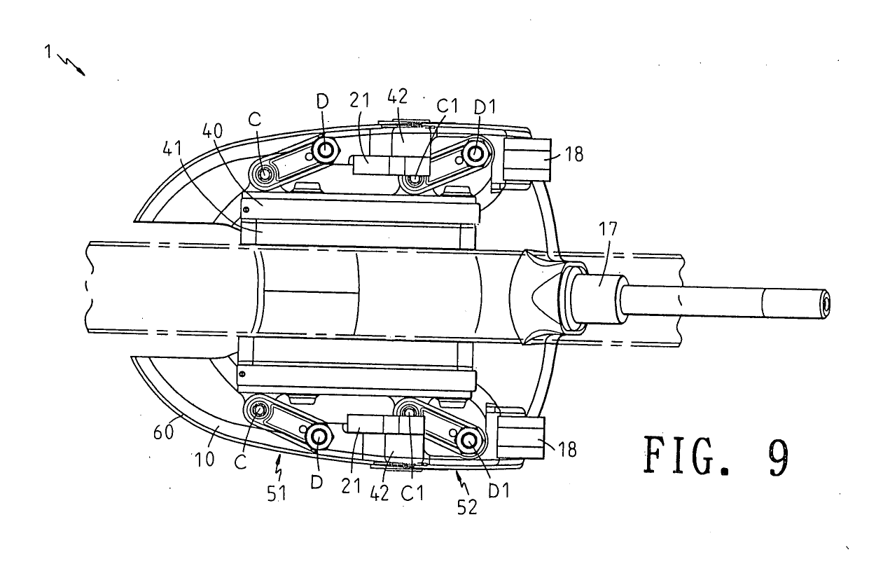

Referring to FIGS. 8 and 9, when the brake cable “B” is pulled, the pivotable member 20 is pivoted about the two pins 22 and the two tubes 42 on the two brake arms 40 are pulled by the two legs 21 of the pivotable member 20 from a first position as shown in FIG. 7 to a second position as shown in FIG. 8. The first and second links 51, 52 are pivoted about the first and second pivotable portion “C” and “C1” and the two brake arms 40 are moved inward to stop the wheel rim. The first and second links 51, 52 are located symmetrically relative to the wheel rim so that the two brake pads 41 of the brake arms 40 simultaneously contact the wheel rim. It is noted that the torsion springs 54 each have a first end connected to the body 10 and the other end of the torsion spring 54 is connected to the support tube 55. When the brake cable “B” is released, the brake arms 40 are pivoted back to their original positions by the torsion springs 54.

The brake cable “B” extends through the front fork “A” so that the length of the brake cable “B” that is exposed is reduced and the inherent shortcoming that the brake cable tangles objects can be effectively reduces.

While we have shown and described the embodiment in accordance with the present invention, it should be clear to those skilled in the art that further embodiments may be made without departing from the scope of the present invention.

What is claimed is:

1. A bicycle brake mechanism comprising:
a body adapted to be located above a front wheel and a pivotable member pivotably connected to the body and adapted to be connected to a brake cable, and
two brake arms located at inside of the body and movably connected to the body by two tubes, each brake arm having a brake pad connected thereto, the two tubes being in contact with the pivotable member so that the two brake arms are moved when the pivotable member is pivoted, two link units pivotably connected to two ends of each of the brake arms and the body so that the two brake arms are moved simultaneously.

2. The mechanism as claimed in claim 1, wherein the body is a U-shaped member and two slots defined through a top of two ends of the body, two plates extend from the two ends of the body, two legs of the pivotable member movably extending through the two slots and each leg including an L-shaped end, two pins extending through the two L-shaped ends and two holes in the two plates to pivotably connect the pivotable member to the body.

3. The mechanism as claimed in claim 1, wherein each of the brake arms has two first lugs extending from a first end thereof and two second lugs extending from a second end thereof, the two tubes are respectively connected to the second lugs of the two brake arms and extend through two first elongate holes defined through the two ends of the body.

4. The mechanism as claimed in claim 1, wherein each of the link units includes two first links and two second links, the first links have a first end pivotably connected to the first lugs of each of the two brake arms, a second end of the first links are pivotably connected to connection lugs on the body, the first links have a first end pivotably connected to the second lugs of each of the two brake arms, a second end of the second links are pivotably connected to a through hole in each of the two ends of the body.

5. The mechanism as claimed in claim 1, wherein a through hole is defined in a top of the body and a connector is engaged with the through hole, the connector is adapted to receive the brake cable.

6. The mechanism as claimed in claim 1, wherein the pivotable member has two top lugs on a center thereof and a securing unit is connected to the two top lugs, the securing unit is adapted to connect an end of the brake cable.

7. The mechanism as claimed in claim 3, wherein a top cap is mounted on the body and includes two second elongate holes which are in alignment with the first elongate holes of the body, the tubes extend through the two second elongate holes.

8. The mechanism as claimed in claim 1, wherein two cushion members are connected to the two ends of the body and adapted to be in contact with the front fork.

9. The mechanism as claimed in claim 1, wherein each of the tubes has an end cap connected to a distal end thereof.

10. The mechanism as claimed in claim 2, wherein the two tubes are located on two respective horizontal sections of the L-shaped ends of the pivotable member.

11. The mechanism as claimed in claim 2, wherein the two pins each have an aperture and a spring clip extends through the aperture to prevent the pin from being pulled backward through the two holes in the two plates of the body.

12. The mechanism as claimed in claim 4, wherein a rod extends through the first end of each of the first links and the first lugs of each of the brake arms to form a first pivotable portion, a bolt extends through the second end of each of the first links, a torsion spring, a support tube for receiving the torsion spring and the connection lugs of each end of the body and is connected to a nut so as to form a first positioning portion, another rod extends through the first end of each of the second links, the tube between the second lugs and the second lugs of each of the brake arms to form a second pivotable portion, another bolt extends through the second end of each of the second links and the through hole of the body and is connected with another a nut so as to form a second positioning portion.

13. The mechanism as claimed in claim 4, wherein the two first links and two second links are oval plates.

14. The mechanism as claimed in claim 6, wherein the securing unit includes a tubular member which extends through the two top lugs and includes a recess defined in an outer periphery thereof, a securing plate is engaged with the recess and a bolt extends through the securing plate to be adapted to secure the brake cable between the securing plate and the recess.

15. The mechanism as claimed in claim 14, wherein the tubular member has a groove defined in an outer periphery of an end thereof and a C-clip is engaged with the groove to position the tubular member.
